(19) United States
(12) Patent Application Publication
(10) Pub. No.: US 2013/0102258 A1
(43) Pub. Date: Apr. 25, 2013

(54) METHOD FOR IMPROVING RADIO FREQUENCY TRANSMISSION RECEPTION

(71) Applicant: David Michael Burke, Taylor, MI (US)

(72) Inventor: David Michael Burke, Taylor, MI (US)

(73) Assignee: EnOcean GmbH

(21) Appl. No.: 13/485,414

(22) Filed: May 31, 2012

Related U.S. Application Data
(60) Provisional application No. 61/493,107, filed on Jun. 3, 2011.

(51) Int. Cl. H04W 24/02

(52) U.S. Cl. CPC H04W 24/02
USPC 455/67.11; 455/88

(57) ABSTRACT

A method and system for improving radio frequency transmission receives a first RF transmission, determines the strength of the transmissions, and adjusts a radio maturity buffer based on the determined strength.

### BACKGROUND

The present disclosure is directed toward radio frequency (RF) transmissions and more particularly toward the use of a radio frequency maturity buffer to improve signal reception.

Electrical systems, such as home lighting systems, often utilize a controller in communication with multiple subsystems, such as individual light fixtures and switches, to generate a controlled environment. In such an electrical system, each of the subsystems communicates with the controller either sporadically, or at regular intervals thereby allowing the controller to control the subsystems. In order to reduce costs associated with the installation of the electrical system, communications between the controller and the subsystems are often wireless, with the transmissions between the controller and the remote systems being powered by an energy harvesting device such as an energy harvesting switch.

Installation of the electrical subsystems throughout a building can place barriers, such as walls and floors, between the subsystems and the controller. The barriers interfere with RF communication between the subsystems and the controllers, and can reduce the signal strength of the received electrical signals causing the received information to be incomplete.

### SUMMARY

In one aspect, a method is disclosed for improving Radio Frequency (RF) transmission including: receiving a first RF transmission; determining a strength of the first RF transmission using a controller; and adjusting a radio maturity buffer, thereby improving signal reception.

In some embodiments, the step of adjusting a radio maturity buffer includes increasing a period of the radio maturity buffer.

In some embodiments, increasing the period of the radio maturity buffer includes a user manually inputting a new radio maturity buffer period into the controller.

In some embodiments, increasing the period of the radio maturity buffer includes the controller automatically calculating a new radio maturity buffer based on the strength of the first RF transmission.

Some embodiments include the step of adjusting a redundancy of the RF transmission based on the strength of the first RF transmission.

In some embodiments, the redundancy of the first transmission is a number of repeated identical messages within a single transmission.

In another aspect, an electrical control system is disclosed including: a first wireless device having at least a receiver and a transmitter, and at least one second wireless device operable to wirelessly communicate with the first wireless device using a redundant telegram. In some embodiments, the second wireless device has a radio buffer maturity defining a time period during which redundant telegrams are a single message. In some embodiments, the first wireless device is further operable to alter the time period, thereby increasing the radio buffer maturity.

In some embodiments, each of the at least one second wireless devices includes a wireless transmitter and a wireless receiver.

In some embodiments, each of the second wireless devices includes a self powered radio switch.

In some embodiments, the first wireless device includes a data entry component operable to allow a user to manually alter the radio buffer maturity.

In some embodiments, the first wireless device includes a data entry component operable to allow a user to enter a manual alteration to the radio maturity buffer.

In some embodiments, the manual alteration includes an increased number of redundant messages within each telegram.

In some embodiments, the manual alteration includes an increased time period of the radio maturity buffer.

In some embodiments, the first wireless device includes a microprocessor operable to perform the steps of: receiving a first RF transmission; determining a strength of the first RF transmission using a controller; and adjusting a radio maturity buffer, thereby improving signal reception.

In another aspect, a method is disclosed for improving RF transmissions including the steps of: monitoring an amount of harvested energy at a remote transmitter and adjusting a redundancy of RF transmissions from the remote transmitter based on an available amount of energy.

In some embodiments, the step of adjusting a redundancy of RF transmissions from the remote transmitter based on an available amount of energy further includes setting the redundancy at a maximum possible value, based on the amount of harvested energy.

In some embodiments, the step of adjusting a redundancy of RF transmissions from the remote transmitter based on an available amount of energy further includes setting the redundancy at a maximum possible value based on a portion of the amount of harvested energy, thereby preventing the harvested energy from being entirely consumed.

In some embodiments, the amount of harvested energy is an amount of energy harvested from a self powering switch.

In some embodiments, the self powering switch harvests mechanical energy from the operation of the switch.

Various embodiments may include any of the above described elements, alone or in any suitable combination.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 illustrates a sample building with a wireless controller controlling multiple electrical subsystems.

FIG. 2 illustrates a wireless controller.

FIG. 3 illustrates a method for compensating for poor signal strength or interference.

FIG. 4 illustrates a method for implementing an increased redundancy in a radio frequency transmission.

### DETAILED DESCRIPTION

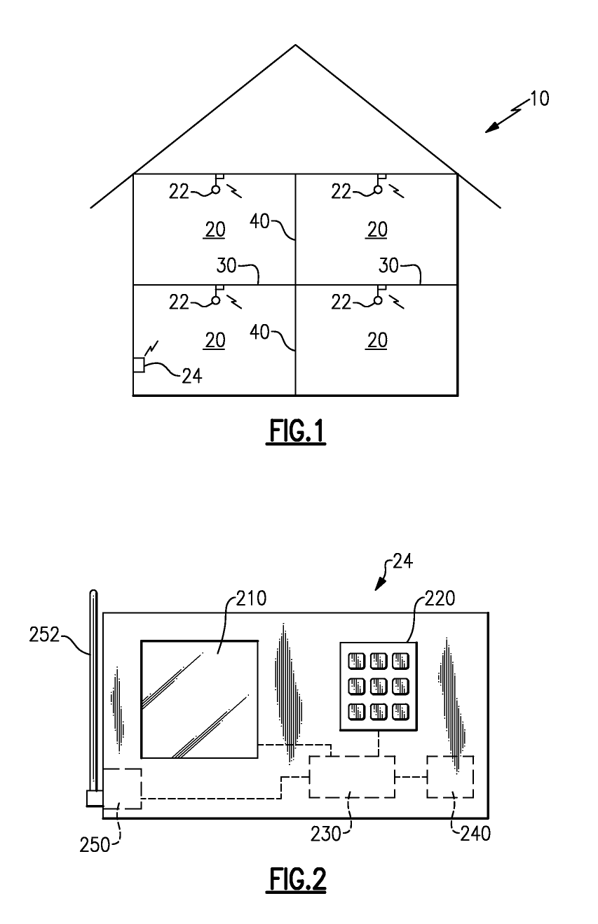

FIG. 1 illustrates a sample building 10, including four rooms 20. Each of the rooms 20 includes an electrical subsystem 22. Also included in the building 10 is a controller 24. The controller 24 is capable of wirelessly communicating with and controlling each of the electrical subsystems 22. While one of the illustrated electrical subsystems 22 is in the same room as the controller 24, the remainder are located throughout the building 10 and are isolated from the controller 24 via floors 30 and walls 40. As a result of the interference of the floors 30 and walls 40, the RF transmissions between each of the electrical subsystems 22 and the controller 24 can have their strength reduced below a level that is readable by the controller 24. While the illustrated example of FIG. 1 includes lighting systems, other electrical subsystems 22 such as room occupancy detectors, electrical outlet controls, or any other electrical system in communication with the controller 24 can also be included.

FIG. 2 illustrates a wireless controller 24 of FIG. 1 in greater detail. The controller 24 has a screen 210 for displaying information to a user. A keypad 220 allows the user to enter information or input commands, thus programming the controller 24. A microprocessor 230 operates the controller 24 according to instructions stored in a memory 240. A wireless transmitter/receiver 250 and an antennae 252 allow the controller 24 to communicate with electrical subsystems 22 (illustrated in FIG. 1), thereby allowing the controller 24 to receive information from, and send instructions to, the electrical subsystems 22.

In order to compensate for poor signal strength and interference, wireless communication systems use a radio maturity buffer. The radio maturity buffer is a time period, beginning from receipt of an initial message, during which the receiving unit determines that duplicate incoming messages are redundant, and not new messages. The radio maturity buffer length is stored in the controller 24 memory 240 and allows the controller 24 to properly interpret identical incoming RF transmissions. A single transmission from one of the electrical subsystems 22 will include multiple redundant messages in order to allow the receiver 250 to compensate for any lost portions of the initial message due to poor signal strength or interference. In cases of particularly strong interference, or particularly weak signal strength, the default radio maturity buffer can be inadequate. In some embodiments, receiver side signal strength ranges from about −100 dBm to −20 dBm, depending on the distance to the transmitter. A strong interferer may have e.g. above −80 dBm RF signal strength.

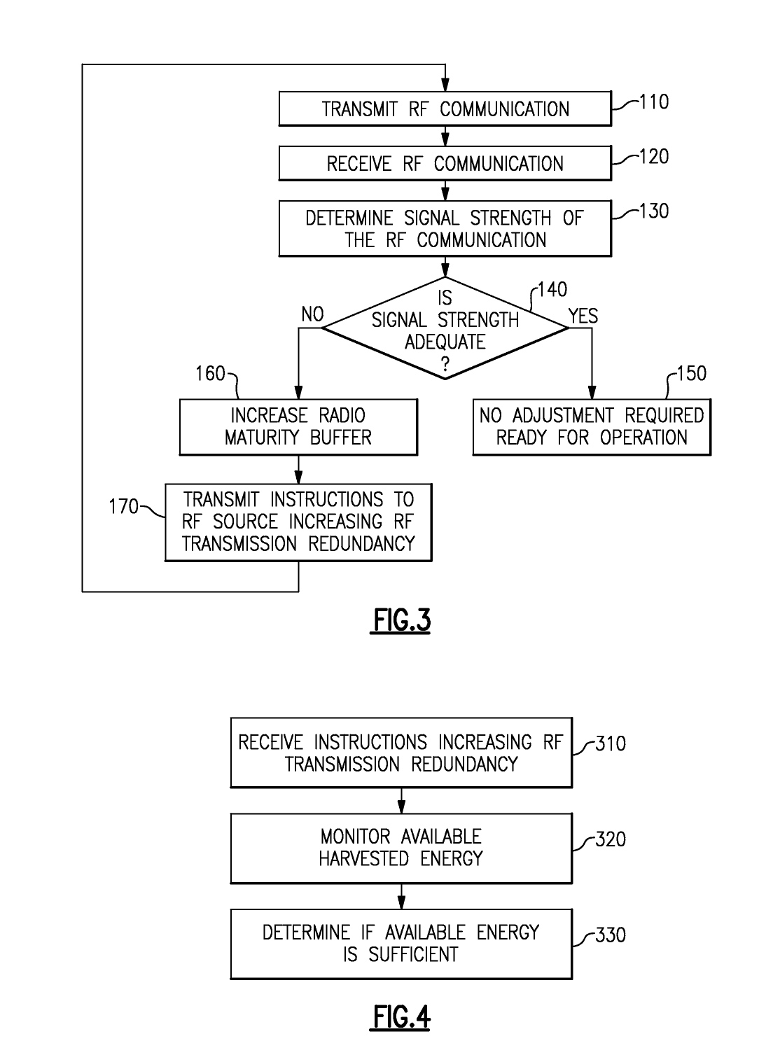

FIG. 3 illustrates a method of compensating for poor signal strength and interference by adjusting the radio maturity buffer and adjusting the redundancy of transmitted messages. Initially, a remote RF source, such as an electrical subsystem 22 (illustrated in FIG. 1) transmits an RF message to the controller 24 (illustrated in FIG. 1) in a “Transmit RF communication” step 110. In some embodiments, the signal length of a single radio telegram ranges from 0.5 ms to 10 ms. A complete chain of several redundant copies of these radio telegrams with pauses in between can, in some embodiments, have a duration of between 5 ms and 200 ms. The RF message is transmitted with a default redundancy. By way of example, one default redundant transmission can include three iterations of the transmitted message.

The initial RF transmission is received by the controller 24 in a “receive RF communication” step 120. Based on the received signal, the controller 24 determines the strength of the RF signal in a “determine signal strength” step 130. The controller 24 uses any known method for determining the signal strength. A common method known in the art is to measure signal power in dBm. The result is than a value, called RSSI (Radio Signal Strength Indicator).

During the “determine a signal strength” step 130, the controller 24 determines the amount of interference on the received RF signal. In order to determine the amount of interference, a known message can be sent as the RF transmission. The controller 24 then checks the received message against the known message and determines the amount of interference present. If the signal strength is adequate, and the interference is low enough, the controller 24 enters a “no adjustment required” step 150 and is ready for standard communications between the controller 24 and the electrical subsystem 22.

Alternately, if the signal strength is inadequate, or the interference is too high, the controller 24 increases the length of a radio maturity buffer in an “adjust radio maturity buffer” step 160. The controller 24 transmits instructions to the original RF source in a “transmit increased radio maturity buffer length” step 170. The transmitted instructions inform the original RF source of the increased radio maturity buffer length, and cause the original RF source to include a corresponding increase in redundancy for future transmissions. In one example, the increased redundancy is proportional to the increased radio maturity buffer. The amount by which the radio maturity buffer is increased can be determined automatically by the controller's microprocessor 230, or input manually by a user configuring the control system using the keypad 220 or using any other user interface option.

After transmitting the increased radio maturity buffer to the electrical subsystem 22, the method returns to the initial step 170, and reiterates, thereby allowing the controller 24 to determine if the new radio maturity buffer is adequate. While the above method is described with regard to a controller 24 altering the radio maturity buffer, it is understood that an electrical subsystem 22 having both transmit and receive capabilities could likewise adjust the radio maturity buffer using the same process to achieve the same affect. Furthermore, it is understood that a similar process can be used to reduce the radio maturity buffer and the redundancy of the transmissions when the signal strength is strong enough or the interference is low enough, thereby recognizing a transmission energy savings.

Often, the transmissions of the remote system are powered by an energy harvesting component that allows the electrical subsystem 22 to harvest energy from ambient conditions, or to harvest energy from repeated mechanical motion (such as activating a switch). One example energy harvesting device that can be used is an EnOcean transmitter switch. When the electrical subsystem 22 uses harvested energy to power RF transmissions, it is important to ensure that the increased redundancy does not entirely deplete the harvested energy.

In various embodiments, the amount of harvested energy depends on the method of harvesting, the energy source and the energy converter setup. For example, in some embodiments, a light switch harvester, pressed one time, can supply an energy ranging from 50 μJoule to 300 μJoule per actuation. In some embodiments, a continuous operating harvester, as a solar cell, can supply powers between a few μWatts and a few Watts as long as light is available. In various embodiments, the energy need for a radio telegram chain (made up of one or multiple redundant radio messages) ranges from 10 μJoule to 1000 μJoule.

FIG. 4 illustrates a method by which the electrical sub systems 22 monitor the available energy resources and adjusts the transmission redundancy to prevent energy depletion. Initially, the electrical subsystem 22 receives instructions increasing a radio maturity buffer from the controller 24 in a “receive instructions increasing RF transmission redundancy” step 310. Once the increased redundancy instructions are received, the electrical subsystem 22 monitors the available energy in a “monitor available harvested energy” step 320.

The available energy can be monitored using any known type of monitoring, e.g., by measuring the voltage of the energy store or measuring the voltage drop if a load is connected to the energy store. During the “monitor available harvested energy” step 32, the electrical subsystem 22 determines if the new transmission redundancy can be sustained with the current amount of harvested energy in a “determine if available energy is sufficient” step 330. If the available energy is sufficient to sustain the desired redundancy, the electrical subsystem 22 implements the new redundancy received from the controller 24, and continues to monitor the available harvested energy.

If the available energy is inadequate to sustain the redundancy from received in the initial instructions, the electrical subsystem 22 instead sets the new redundancy at a maximum possible value based on a portion of the harvested energy that can be used for each RF transmission, rather than the maximum possible redundancy for the new radio maturity buffer length, thereby ensuring that the harvested energy is not entirely exhausted in a single RF transmission. Alternately, if maximum signal strength is desired and the electrical subsystem 22 is capable of harvesting energy rapidly, the electrical subsystem 22 can set the redundancy at an amount that exhausts the harvested energy in a single RF transmission, but does not exceed the available energy.

Although an example embodiment has been disclosed, a worker of ordinary skill in this art would recognize that certain modifications would come within the scope of this disclosure. For that reason, the following claims should be studied to determine the true scope and content of this disclosure.

What is claimed is:

1. A method for improving Radio Frequency (RF) transmission comprising the steps of:
receiving a first RF transmission;
determining a strength of the first RF transmission using a controller; and
adjusting a radio maturity buffer, thereby improving signal reception.

2. The method of claim 1, wherein the step of adjusting a radio maturity buffer comprises increasing a period of said radio maturity buffer.

3. The method of claim 2, wherein increasing said period of said radio maturity buffer comprises a user manually inputting a new radio maturity buffer period into said controller.

4. The method of claim 2, wherein increasing said period of said radio maturity buffer comprises said controller automatically calculating a new radio maturity buffer based on said strength of the first RF transmission.

5. The method of claim 1, further comprising the step of adjusting a redundancy of said RF transmission based on said strength of said first RF transmission.

6. The method of claim 5, wherein said redundancy of said first transmission is a number of repeated identical messages within a single transmission.

7. An electrical control system comprising;
a first wireless device having at least a receiver and a transmitter;
at least one second wireless device operable to wirelessly communicate with said first wireless device using a redundant telegram;
said second wireless device having a radio buffer maturity defining a time period during which redundant telegrams are a single message;
said first wireless device further operable to alter said time period, thereby increasing the radio buffer maturity.

8. The electrical system of claim 7, wherein each of said at least one second wireless devices comprises a wireless transmitter and a wireless receiver.

9. The electrical system of claim 7, wherein each of said second wireless devices comprises a self powered radio switch.

10. The electrical system of claim 7, wherein said first wireless device comprises a data entry component operable to allow a user to manually alter said radio buffer maturity.

11. The electrical system of claim 7, wherein said first wireless device comprises a data entry component operable to allow a user to enter a manual alteration to said radio maturity buffer.

12. The electrical system of claim 11, wherein said manual alteration comprises an increased number of redundant messages within each telegram.

13. The electrical system of claim 11, wherein said manual alteration comprises an increased time period of said radio maturity buffer.

14. The electrical system of claim 7, wherein said first wireless device comprises a microprocessor operable to perform the steps of:
receiving a first RF transmission;
determining a strength of the first RF transmission using a controller; and
adjusting a radio maturity buffer, thereby improving signal reception.

15. A method for improving Radio Frequency (RF) transmissions comprising the steps of:
monitoring an amount of harvested energy at a remote transmitter; and
adjusting a redundancy of RF transmissions from said remote transmitter based on an available amount of energy.

16. The method of claim 15, wherein said step of adjusting a redundancy of RF transmissions from said remote transmitter based on an available amount of energy further comprises setting said redundancy at a maximum possible value, based on said amount of harvested energy.

17. The method of claim 15, wherein said step of adjusting a redundancy of RF transmissions from said remote transmitter based on an available amount of energy further comprises setting said redundancy at a maximum possible value based on a portion of said amount of harvested energy, thereby preventing said harvested energy from being entirely consumed.

18. The method of claim 15, wherein said amount of harvested energy is an amount of energy harvested from a self powering switch.

19. The method of claim 18, wherein said self powering switch harvests mechanical energy from the operation of the switch.
